(19) United States
(12) Patent Application Publication
(10) Pub. No.: US 2012/0096712 A1
(43) Pub. Date: Apr. 26, 2012

(54) APPARATUS AND METHOD FOR ASSEMBLING A COMPRESSION-TYPE CONNECTOR TO A CABLE

(75) Inventors: Shawn M. Chawgo, Cicero, NY (US); Noah Montena, Syracuse, NY (US)

(73) Assignee: John Mezzalingua Associates, Inc.

(21) Appl. No.: 12/911,820

(22) Filed: Oct. 26, 2010

(51) Int. Cl. H01R 43/00

(52) U.S. Cl. 29/857

(57) ABSTRACT

A method of assembling a connector to a cable with a length. The method includes the steps of: providing a connector with first and second relatively movable parts; providing an apparatus with a frame defining a bearing surface, a force applying assembly, and an advancing assembly including a threaded component; placing the connector in a pre-assembly position on the cable; reinforcing the first part of the connector against the bearing surface; and turning the threaded component around an axis to thereby advance a part of the force applying assembly against the connector in a line that is substantially parallel to the length of the cable to thereby cause the first and second parts to be relatively moved from a pre-assembly state into an assembled state, wherein the connector is mechanically and electrically connected to the cable.

### BACKGROUND OF THE INVENTION

1. Field of the Invention

This invention relates to connectors for cable and, more particularly, to connectors that are assembled under a compressive force applied lengthwise of the cable.

2. Background Art

There currently exist many different configurations of connectors for coaxial cable that are assembled in many different manners. One such connector design is assembled by relatively moving at least two parts under a compressive force applied in a direction lengthwise with respect to the associated cable. As the parts are relatively moved, they cooperate with each other and/or the cable in a manner that portions of the cable become positively captively held, thereby causing the connector to be positively maintained at the cable end. In the case of coaxial cable, at least one of the parts must be squeezed between component layers on the cable during the assembly process. As this occurs, one or more of the component layers must be deformed. Some such connectors also rely upon radial deformation of component layers, such as an outer sheath, to maintain the necessary integrity of the union of the connector and cable.

Cable, such as coaxial cable, currently exists with a range of different properties, which may be attributable to different grade, quality, or configuration. As a result of these differences, and potentially the nature of the connector itself, the required magnitude of the assembly forces may vary over a wide range. For example, the elasticity and hardness of component layers may be significantly different from one cable to the next. Generally, lower elasticity necessitates a greater assembly force to press one or more connector parts between adjacent cable layers. A harder sheath layer necessitates greater force application to produce the requisite gripping deformation of that layer. Corrugated connectors add another dimension to the assembly challenge.

Heretofore, compression tools have commonly been designed to be hand-holdable to facilitate on-site connector assembly. Some such tools are made with two graspable handles that are relatively pivoted to apply a captive, compressive force between parts of at least two components on the connector. The tools commonly use a toggle arrangement to exploit mechanical advantage.

While the above type of compression tool is generally effective, it has a number of limitations. Even though these tools are normally designed to be operable through a gripping force applied through a user's one hand, a certain and significant hand strength is required to move the connector parts to the extent required to properly complete assembly. Failure to apply the requisite force may compromise the assembly process, which could result in improper sealing, improper connection, or in a worst case, a failed connection.

Some users may not have the requisite strength to effectively use this conventional tool configuration. A user's strength may diminish as he/she fatigues, as after the assembly of numerous connectors through repetitive action. An injury could also compromise a user's ability to effectively use such tools.

The above problems are aggravated by the fact that the characteristics of the cable may be undesirably altered by the environment. In very cold conditions, as one might anticipate encountering in outdoor cable servicing, certain materials and component layers become more inelastic and harder. This makes even more difficult the assembly process and may lead to situations wherein either an ineffective assembly is performed or the technician cannot effect the assembly at all. The former may lead to a return service call. The latter may necessitate on-site improvisation using other tools and/or processes to assemble the connector, or a return trip with different equipment.

In many industries in which cable connectors are applied, such as the communications industry, profit margins are relatively low. To effectively compete, technicians representing businesses must be able to efficiently and effectively carry out installations and repairs. Ineffective tool performance is particularly troublesome in this regard.

In spite of the above problems associated with compression-type connectors, the industry has yet, to the knowledge of the inventors herein, come up with a tool or method that can be practically used to effect assembly of compression-type connectors requiring the application of large assembly forces. The industry continues to seek out designs that address all of the above problems.

### SUMMARY OF THE INVENTION

In one form, the invention is directed to a method of assembling a connector to a cable with a length. The method includes the steps of providing a connector with first and second relatively movable parts; providing an apparatus with a frame defining a bearing surface, a force applying assembly, and an advancing assembly including a threaded component; placing the connector in a pre-assembly position on the cable; reinforcing the first part of the connector against the bearing surface; and turning the threaded component around an axis to thereby advance a part of the force applying assembly against the connector in a line that is substantially parallel to the length of the cable to thereby cause the first and second parts to be relatively moved from a pre-assembly state into an assembled state, wherein the connector is mechanically and electrically connected to the cable.

In one form, the step of providing an apparatus involves providing an apparatus wherein the threaded component is threadably connected directly to the frame.

In one form, the step of reinforcing the first part of the connector involves reinforcing the first part of the connector directly against the frame.

In one form, the step of providing an apparatus involves providing an apparatus with a single piece that defines the part of the force applying assembly and the threaded component.

In one form, the step of providing an apparatus involves providing an apparatus with a self-powered drive that is operated to turn the threaded component around the axis.

In one form, the step of providing an apparatus involves providing an apparatus with a turning tool that can be engaged with the threaded component.

In one form, the step of providing an apparatus involves providing an apparatus wherein the frame has a wall that extends substantially continuously around a cavity within which the first and second connector parts and the part of the force applying assembly reside.

In one form, the step of providing an apparatus involves providing an apparatus wherein the frame has a discrete opening defining a cradle for the cable.

In one form, the step of providing an apparatus involves providing an apparatus wherein the frame has a rectangular shape around the cavity with a long dimension and a short dimension. The length of the cable in the cradle is parallel to the long dimension and is substantially coincident with the axis around which the threaded component is turned.

In one form, the step of providing an apparatus involves providing an apparatus wherein the frame defines a U-shaped receptacle extending substantially fully between locations at which the part of the force applying assembly engages the connector and at which the connector is reinforced.

In one form, the step of providing an apparatus involves providing an apparatus wherein the apparatus has an overall cylindrical shape between ends of the apparatus spaced parallel to the length of the cable.

In one form, the step of providing an apparatus involves providing an apparatus wherein the frame has a discrete opening that defines a cradle for the cable and at least one repositionable component. The method further includes the step of moving the repositionable component to thereby maintain the cable in the cradle.

In one form, the step of providing an apparatus involves providing an apparatus with a handle portion that can be surroundingly grasped in a user's hand. The method further includes the step of grasping the handle portion as the threaded component is turned around the axis.

The invention also is directed to a combination including: a) a cable having a length; b) a connector having an axis and first and second parts that are relatively movable along the axis between a pre-assembly state and an assembled state, with the connector mechanically and electrically connected to the cable with the first and second parts in the assembled state; and c) an apparatus for repositioning the first and second parts to thereby change the first and second parts from the pre-assembly state into the assembly state. The apparatus has a frame defining a bearing surface for reinforcing the connector and a threaded component that is turned to advance a part against the reinforced connector in a direction parallel to the length of the cable.

In one form, the frame has a portion that is graspable in a hand of a user as the apparatus is operated to change the state of the first and second parts.

In one form, the frame has a discrete opening that defines a cradle for the cable.

In one form, the frame has a wall that extends continuously around a cavity within which the first and second components reside.

In one form the invention further includes a self-powered tool that is operated to turn the threaded component.

The invention is further directed to the combination of: a) a cable; b) a connector having an axis and first and second parts that are relatively movable along the axis between a pre-assembly state and an assembled state, with the connector mechanically and electrically connected to the cable with the first and second parts in the assembled state; and c) an apparatus for assembling the connector to the cable. The apparatus has: i) a frame; ii) structure on the frame for supporting the cable and connector in an operative position; and iii) structure on the frame for changing the parts on the connector in the operative position from the pre-assembly state into the assembled state.

In one form, the cable is a coaxial cable.

### BRIEF DESCRIPTION OF THE DRAWINGS

FIG. 1 is a schematic representation of an exemplary cable and connector that can be assembled according to the invention;

FIG. 2 is a perspective view of one form of inventive apparatus for assembling a connector, as in FIG. 1, to a cable and with the apparatus in a first state;

FIG. 3 is a view as in FIG. 2 wherein a force applying assembly has been advanced towards a location where the connector resides preparatory to assembly; and

FIG. 4 is a perspective view of a modified form of inventive apparatus.

### DETAILED DESCRIPTION OF THE PREFERRED EMBODIMENT

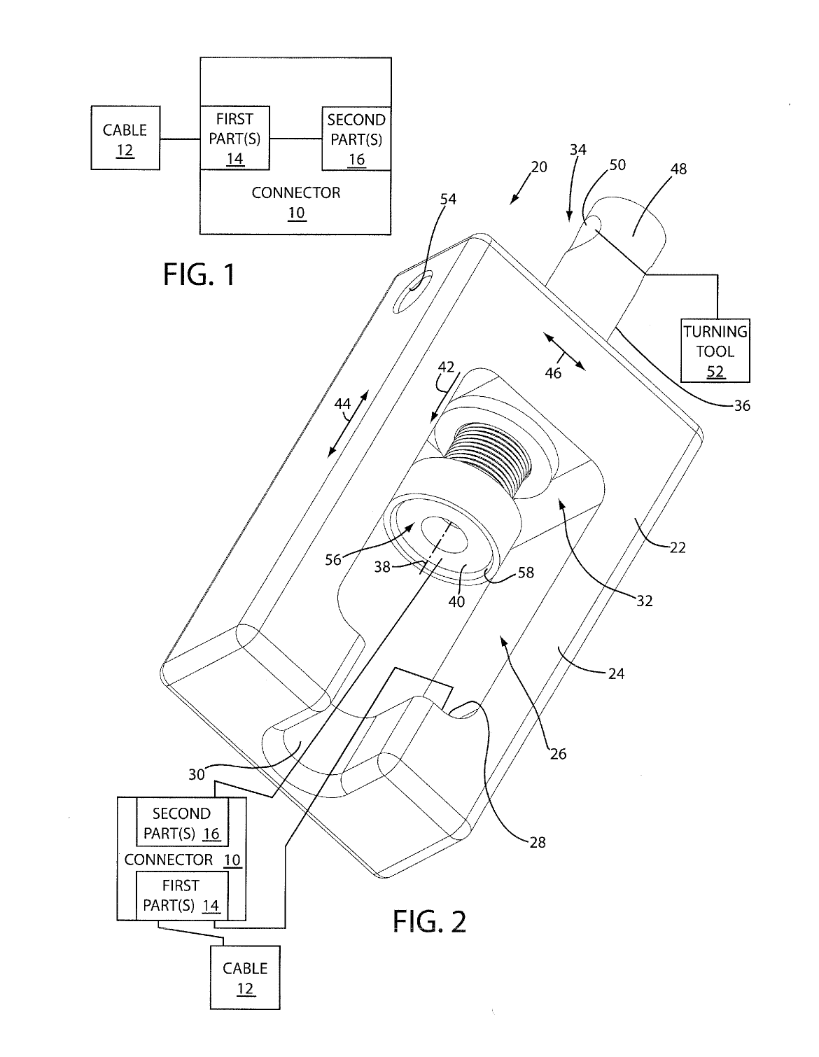

Referring initially to FIG. 1, one connector 10 is shown in schematic form to represent a universe of compression-type connectors that are assembled to a cable 12 and to which the present invention is directed. The connector 10 consists of at least first and second parts 14, 16. At least one of the first and second parts 14, 16 defines a receptacle into which the cable 12 can be preliminarily directed into a pre-assembly position. By thereafter relatively moving the first and second parts 14, 16, the connector 10 becomes mechanically and/or electrically connected to the cable 12. The precise nature of the connector 10 is not critical to the present invention. The invention can be practiced with virtually any type of connector 10 that requires forced relative movement of first and second parts along a line generally parallel to the cable length to effect assembly.

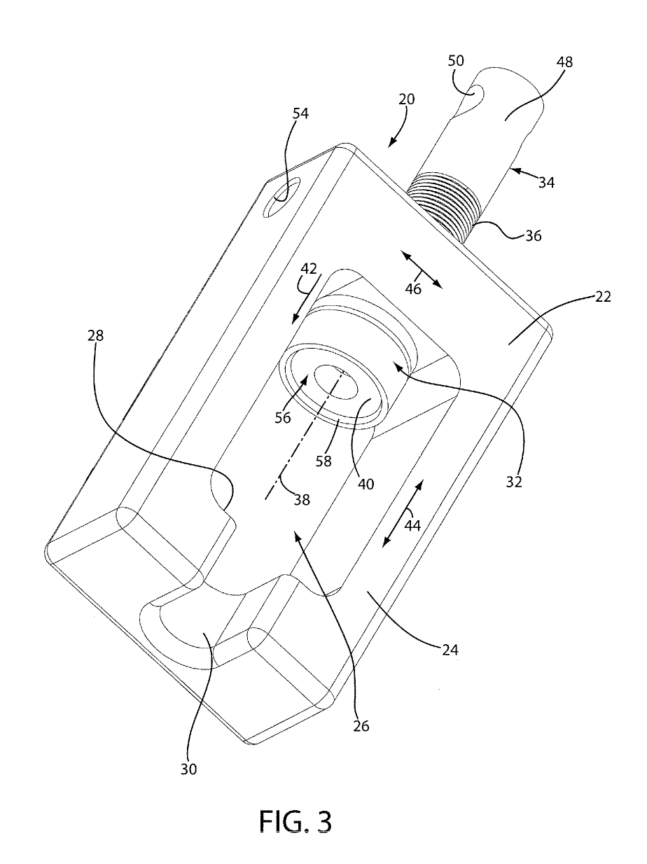

In FIGS. 2 and 3, one specific form of apparatus, for assembling the connector 10 to the cable 12, is shown at 20. The apparatus 20 has a frame 22 with a wall 24 that extends continuously around a cavity 26 within which the connector parts 14, 16 reside with the cable 12 and connector parts 14, 16 in an operative position preparatory to final assembly of the connector 10. In the operative position, shown schematically in FIG. 2, the cable 12 projects into a receptacle defined by at least one of the first and second parts 14, 16. With the cable 12 and connector 10 so engaged, the connector 10 is situated in the cavity 26 so that the first connector part 14 abuts to a bearing surface 28 bounding a portion of the cavity 26. With the cable 12 and connector 10 in the operative position, the cable 12 projects through a discrete opening 30 in the frame 22 that defines a cradle for the cable 12.

A force applying assembly 32 is associated with an advancing assembly 34 that includes a threaded component 36 that engages cooperating threads (not shown) on the frame 22 for turning around an axis 38. The axis 38 is shown to be substantially coincident with the central axis of the cable 12, with the cable 12 and connector 10 in the operative position.

Turning of the threaded component 36 in one direction around the axis 38 causes a leading part 40 of the force applying assembly 32, that resides within the cavity 26, to be advanced axially, as indicated by the arrow 42, from a starting position in FIG. 2, to and potentially beyond the FIG. 3 position. Continued turning of the threaded component 36 causes the leading part 40 to bear forcibly against the second connector part 16, which is thereby advanced towards the first connector part 14 that is reinforced by the bearing surface 28 on the frame 22. With the connector preliminarily joined to the cable 12 and the connector parts 14, 16 in the pre-assembly state, continued advancement of the leading part 40 of the force applying assembly 32 causes the connector parts 14,16 to relatively move, thereby to place the connector parts 14, 16 in the assembled state.

In this embodiment, the frame 22 has a rectangular shape with a long dimension, as indicated by the double-headed arrow 44, and a short dimension, as indicated by the double-headed arrow 46. The components are arranged so that the length of the cable 12, in the operative position, and the axis 38, run substantially parallel to the long dimension of the frame 22.

With this arrangement, potentially the frame 22 has a shape that can be grasped in a hand of a user as the threaded component 36 is turned to assemble the connector 10 to the cable 12. To facilitate turning of the threaded component 36, a cylindrical portion 48 of the component 36 is provided with a through cross bore 50. The cross bore 50 defines a receiver for a turning tool 52 that, in its simplest form, might be an elongate rod. A screwdriver could be used for this purpose. Alternatively, the turning tool 52, or the portion 48 itself, might be more refined in form and customized to allow comfortable grasping and repositioning to effect turning of the threaded component 36.

With the design shown, a single piece defines that part of the advancing assembly 34 consisting of the threaded component 36 and at least part of the force applying assembly 32. This single piece might be stored in the cavity 26 to compact the overall shape of the apparatus, as for storage. A separate frame bore 54 is located to register with the cross bore 50, as to allow the aforementioned turning tool 52, or some other component, to be directed therethrough to releasably maintain the tool 52 and frame 22 in a stored state.

The turning tool 52 may alternatively be in the form of a self-powered drive that is operated to effect appropriate turning of the threaded component 36. For example, the powered tool 52 might be a drill or other structure that can be connected to turn the threaded component 36.

A typical method of assembling the connector 10 to the cable 12 will now be described. The connector 10 is placed in the aforementioned pre-assembly position on the cable 12. The cable 12 and connector 10 are placed in an operative position wherein the cable 12 projects through the discrete opening 30 and the first connector part 14 abuts to the bearing surface 28 on the frame 22 to be supported thereby. The threaded component 36 is either manually turned or turned using a self-powered drive. This advances the leading part 40 of the force applying assembly 32 progressively towards and eventually against the second connector part 16. Continued advancement of the leading part 40 causes the first and second connector parts 14, 16 to be relatively moved from the pre-assembly state into the assembled state, wherein the connector 10 is mechanically and/or electrically connected to the cable 12.

The leading part 40 on the force applying assembly 32 has an undercut seat 56 against which the second connector part 16 seats. An annular rim 58 around the seat 56 performs a centering function to maintain the cable 12 and connector 10 at least nominally coincident with the axis 38.

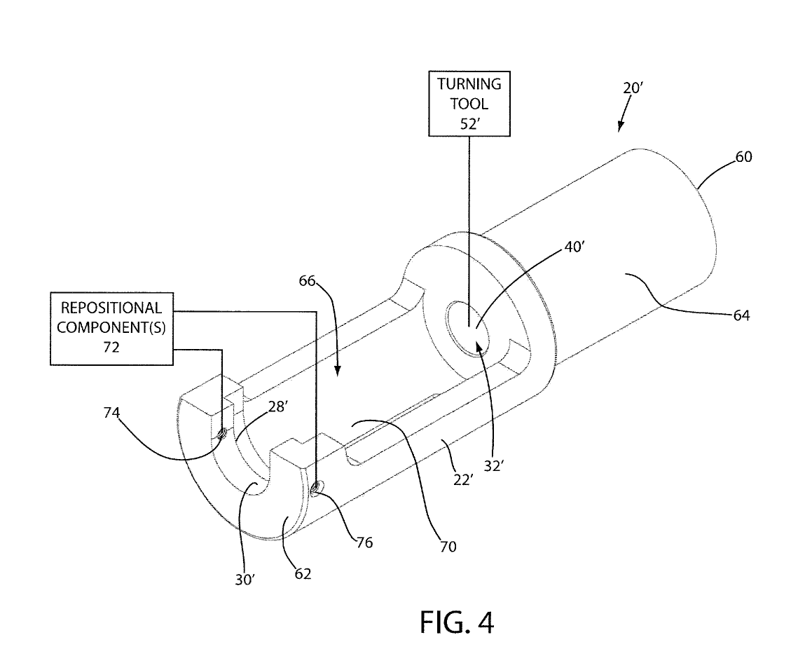

In FIG. 4, a modified form of the apparatus 20 is shown at 20′. Parts in FIG. 4, corresponding to those in FIG. 2, are identified with the same numbers and a “′” designation. The apparatus 20′ has an overall cylindrical shape between its lengthwise ends 60, 62. At the one end 60, a handle part 64 is provided. The handle part 64 has a cylindrical shape that can be surroundingly grasped in a hand of a user while the apparatus 20′ is being used. A U-shaped receptacle 66 is provided fully between locations where a leading part 40′ of a corresponding force applying assembly 32′ may engage the connector 10 and where the connector 10 is supported at a bearing surface 28′. The frame 22′ has a discrete opening 30′ that defines a cradle for the cable 12 with the cable 12 and connector 10 in a corresponding operative position.

The advancing assembly 34′ may be hand operated or controlled through a like turning tool 52′ that may be one that is manually operated or one that is self-powered, as for the tool 52.

With the construction in FIG. 4, the cable 12 can be pressed into the cradle defined by the discrete opening 30′ so that the connector, in its pre-assembly position, resides within the receptacle 66 corresponding to the cavity 26. The receptacle 66 performs the same function as the cavity 26 with the exception that a surface 70 bounding the receptacle 66 additionally supports the connector 10 with the connector parts 14, 16 in both the pre-assembly and assembled states.

With the cable 12 nested in the cradle defined by the opening 30′, one or more repositionable components 72 can be directed through threaded bores 74, 76 to block the cable 12 in the cradle.

The assembly process is otherwise carried out using the apparatus 20′ in the same manner as for the apparatus 20.

The invention contemplates numerous variations from the structure specifically disclosed. For example, the first cable part 14 may be reinforced indirectly, as through the cable 12. This type of indirect reinforcement is contemplated to be within the inventive teachings.

While both embodiments of the apparatus 20, 20′ are hand-holdable, this is not a requirement. This configuration is preferred because the overall apparatus 20, 20′ can be conveniently stored, transported and handled in operation.

Within the description of “threads” is contemplated structure that permits turning using components with a steep rise, whereby multiple turns of components may be avoided.

The foregoing disclosure of specific embodiments is intended to be illustrative of the broad concepts comprehended by the invention.

1. A method of assembling a connector to a cable with a length, the method comprising the steps of:
providing a connector with first and second relatively movable parts;
providing an apparatus comprising a frame defining a bearing surface, a force applying assembly, and an advancing assembly comprising a threaded component;
placing the connector in a pre-assembly position on the cable;
reinforcing the first part of the connector against the bearing surface; and
turning the threaded component around an axis to thereby advance a part of the force applying assembly against the connector in a line that is substantially parallel to the length of the cable to thereby cause the first and second parts to be relatively moved from a pre-assembly state into an assembled state wherein the connector is mechanically and electrically connected to the cable.

2. The method of assembling a connector to a cable according to claim 1 wherein the step of providing an apparatus comprises providing an apparatus wherein the threaded component is threadably connected directly to the frame.

3. The method of assembling a connector to a cable according to claim 1 wherein the step of reinforcing the first part of the connector comprises reinforcing the first part of the connector directly against the frame.

4. The method of assembling a connector to a cable according to claim 1 wherein the step of providing an apparatus comprises providing an apparatus with a single piece that defines the part of the force applying assembly and the threaded component.

5. The method of assembling a connector to a cable according to claim 1 wherein the step of providing an apparatus comprises providing an apparatus with a self-powered drive that is operated to turn the threaded component around the axis.

6. The method of assembling a connector to a cable according to claim 1 wherein the step of providing an apparatus comprises providing an apparatus with a turning tool that can be engaged with the threaded component.

7. The method of assembling a connector to a cable according to claim 1 wherein the step of providing an apparatus comprises providing an apparatus wherein the frame has a wall that extends substantially continuously around a cavity within which the first and second connector parts and the part of the force applying assembly reside.

8. The method of assembling a connector to a cable according to claim 7 wherein the step of providing an apparatus comprises providing an apparatus wherein the frame has a discrete opening defining a cradle for the cable.

9. The method of assembling a connector to a cable according to claim 8 wherein the step of providing an apparatus comprises providing an apparatus wherein the frame has a rectangular shape around the cavity with a long dimension and a short dimension, the length of the cable in the cradle is parallel to the long dimension and is substantially coincident with the axis around which the threaded component is turned.

10. The method of assembling a connector to a cable according to claim 1 wherein the step of providing an apparatus comprises providing an apparatus wherein the frame defines a U-shaped receptacle extending substantially fully between locations at which the part of the force applying assembly engages the connector and at which the connector is reinforced.

11. The method of assembling a connector to a cable according to claim 10 wherein the step of providing an apparatus comprises providing an apparatus wherein the apparatus has an overall cylindrical shape between ends of the apparatus spaced parallel to the length of the cable.

12. The method of assembling a connector to a cable according to claim 11 wherein the step of providing an apparatus comprises providing an apparatus wherein the frame has a discrete opening that defines a cradle for the cable and at least one repositionable component and further comprising the step of moving the repositionable component to thereby maintain the cable in the cradle.

13. The method of assembling a connector to a cable according to clam 1 wherein the step of providing an apparatus comprises providing an apparatus with a handle portion that can be surroundingly grasped in a user's hand and further comprising the step of grasping the handle portion as the threaded component is turned around the axis.

14. In combination:
a) a cable having a length;
b) a connector having an axis and first and second parts that are relatively movable along the axis between a pre-assembly state and an assembled state,
the connector mechanically and electrically connected to the cable with the first and second parts in the assembled state; and
c) an apparatus for repositioning the first and second parts to thereby change the first and second parts from the pre-assembly state into the assembly state,
the apparatus comprising a frame defining a bearing surface for reinforcing the connector and a threaded component that is turned to advance a part against the reinforced connector in a direction parallel to the length of the cable.

15. The combination according to claim 14 wherein the frame has a portion that is graspable in a hand of a user as the apparatus is operated to change the state of the first and second parts.

16. The combination according to claim 14 wherein the frame has a discrete opening that defines a cradle for the cable.

17. The combination according to claim 14 wherein the frame has a wall that extends continuously around a cavity within which the first and second components reside.

18. The combination according to claim 14 further comprising a self-powered tool that is operated to turn the threaded component.

19. In combination:
a) a cable;
b) a connector having an axis and first and second parts that are relatively movable along the axis between a pre-assembly state and an assembled state,
the connector mechanically and electrically connected to the cable with the first and second parts in the assembled state; and
c) an apparatus for assembling the connector to the cable, the apparatus comprising:
i) a frame;
ii) means on the frame for supporting the cable and connector in an operative position; and
iii) means on the frame for changing the parts on the connector in the operative position from the pre-assembly state into the assembled state.

20. The combination according to claim 19 wherein the cable is a coaxial cable.
